(19) United States
(12) Patent Application Publication
(10) Pub. No.: US 2025/0260463 A1
(43) Pub. Date: Aug. 14, 2025

(54) A METHOD FOR CONFIGURING TRANSMISSION RESOURCES FOR A USER EQUIPMENT, A RADIO NETWORK NODE AND A USER EQUIPMENT

(71) Applicant: Sony Group Corporation, Tokyo (JP)

(72) Inventors: Erik BENGTSSON, Eslöv (SE); Fredrik RUSEK, Eslöv (SE); Jose FLORDELIS, Lund (SE); Kun ZHAO, Malmö (SE); Olof ZANDER, Södra Sandby (SE)

(21) Appl. No.: 18/857,704

(22) PCT Filed: Apr. 24, 2023
(86) PCT No.: PCT/EP2023/060635

§ 371 Date: Oct. 17, 2024

(30) Foreign Application Priority Data
Apr. 29, 2022 (SE) 2250522-6

(51) Int. Cl. H04B 7/06; H04W 72/044

(52) U.S. Cl. CPC H04B 7/0691; H04W 72/044

(57) ABSTRACT

A method is disclosed, performed by a radio network node, for configuring transmission resources for a user equipment is disclosed. The method comprises receiving, from the user equipment, a message indicative of one or more available transmit antenna combinations of the user equipment. In one or more example methods each transmit antenna combination is associated with one or more frequency bands. The method comprises transmitting, to the user equipment, based on the received message, information indicative of resources to be used by the user equipment for transmission.

The present disclosure pertains to the field of wireless communications. The present disclosure relates to a method for configuring transmission resources for a user equipment, a method for enabling a radio network node to configure transmission resources for the user equipment, a related radio network node and a related user equipment.

### BACKGROUND

In a 3rd Generation Partnership Project (3GPP) Long Term Evolution (LTE) and/or 5G network, the radio network node has to configure the UE with sufficient resources, such as SRS resources, for the UE to perform antenna switching to obtain a full channel information and optimized antenna selections. The current methods are not efficient in terms of resource efficiency as all UEs are not behaving in exactly the same way, and/or have different properties. There is thus room for improvement of the methods for configuring the resources for the UE.

### SUMMARY

Accordingly, there is a need for devices and methods for configuring transmission resources for a user equipment, which may mitigate, alleviate or address the shortcomings existing and may provide a more efficient scheduling of the transmit antennas of the user equipment.

A method is disclosed, performed by a radio network node, for configuring transmission resources for a user equipment. The method comprises receiving, from the user equipment, a message indicative of one or more available transmit antenna combinations of the user equipment for contemporaneous transmission. In one or more example methods each transmit antenna combination is associated with one or more frequency bands. The method comprises transmitting, to the user equipment, based on the received message, information indicative of resources to be used by the user equipment for transmission.

Further, a radio network node is provided, the radio network node comprising memory circuitry, processor circuitry, and a wireless interface. The radio network node is configured to perform any of the methods disclosed herein and relating to the radio network node.

It is an advantage of the present disclosure that the radio network node can receive information about the available transmit antenna configurations and/or transmit antenna capabilities of the user equipment. Based on the information about the user equipment's transmit antenna configuration, the radio network node can determine and configure a more efficient resource scheduling for the transmit antenna configuration of the user equipment.

A method is disclosed, performed by a user equipment, for enabling a radio network node to configure transmission resources for the user equipment is disclosed. The method comprises transmitting, to the radio network node, a message indicative of one or more available transmit antenna combinations of the user equipment for contemporaneous transmission. Each transmit antenna combination is associated with one or more frequency bands. In one or more example methods, the method comprises receiving, from the radio network node, based on the received information, information indicative of resources to be used by the user equipment for transmission.

Further, a user equipment is provided, the user equipment comprising memory circuitry, processor circuitry, and a wireless interface. The user equipment is configured to perform any of the methods disclosed herein and relating to the user equipment.

It is an advantage of the present disclosure that the user equipment can inform the radio network node about the available transmit antenna configurations and/or transmit antenna capabilities of the user equipment. This enables the radio network node to, based on the information about the user equipment's transmit antenna configuration, determine and configure a more efficient resource scheduling for the transmit antenna configuration of the user equipment.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a diagram illustrating an example antenna switching scheme for a UE according to this disclosure,

FIG. 3 is a diagram illustrating an example antenna configuration in a user equipment according to this disclosure,

FIG. 4 is a flow-chart illustrating an example method, performed in a radio network node, for configuring transmission resources for a user equipment according to this disclosure,

FIG. 5 is a flow-chart illustrating an example method, performed in a user equipment, for enabling a radio network node to configure transmission resources for the user equipment according to this disclosure,

FIG. 6 is a block diagram illustrating an example radio network node according to this disclosure,

FIG. 7 is a block diagram illustrating an example user equipment according to this disclosure,

FIG. 8 is a block diagram illustrating an example antenna configuration in a user equipment according to this disclosure, and

FIG. 9 is a block diagram illustrating an example antenna configuration in a user equipment according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

According to the current disclosure the UE can signal information about its UE antenna configuration and frequency bands to the radio network node which enables the radio network node to perform resource scheduling in a more efficient manner. Without the UE informing the radio network node about its transmit antenna configuration, the network would have to assume the least information possible, which renders advanced UE implementations useless. An alternative solution is to perform on-a-need-basis feedback, i.e., if an indicated network configuration from the network is not possible at the UE, then UE feedback is required. This alternative solution however increases overhead and latency. Hence, the current disclosure provides may reduce the overhead and latency related to communications for enabling resource scheduling.

The figures are schematic and simplified for clarity, and they merely show details which aid understanding the disclosure, while other details have been left out. Throughout, the same reference numerals are used for identical or corresponding parts.

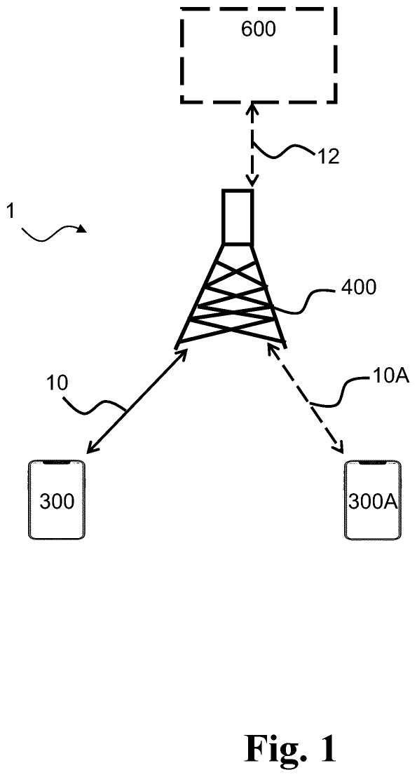

FIG. 1 is a diagram illustrating an example wireless communication system 1 comprising an example core network (CN) node 600, an example radio network node 400 and an example user equipment (UE) 300 according to this disclosure.

As discussed in detail herein, the present disclosure relates to a wireless communication system 1 comprising a cellular system, for example, a 3GPP wireless communication system. The wireless communication system 1 comprises a UE 300 and/or a radio network node 400.

A radio network node disclosed herein refers to a radio access network node operating in the radio access network, such as a base station, an evolved Node B, eNB, gNB in NR. In one or more examples, the RAN node is a functional unit which may be distributed in several physical units.

A CN node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the network node, such as the CN node and/or the radio network node, is a functional unit which may be distributed in several physical units.

The wireless communication system 1 described herein may comprise one or more UEs 300, 300A, and/or one or more radio network nodes 400, such as one or more of: a base station, an eNB, a gNB and/or an access point.

A UE may refer to a mobile device and/or a wireless device (WD).

The UE 300, 300A may be configured to communicate with the network node 400 via a wireless link (or radio access link) 10, 10A.

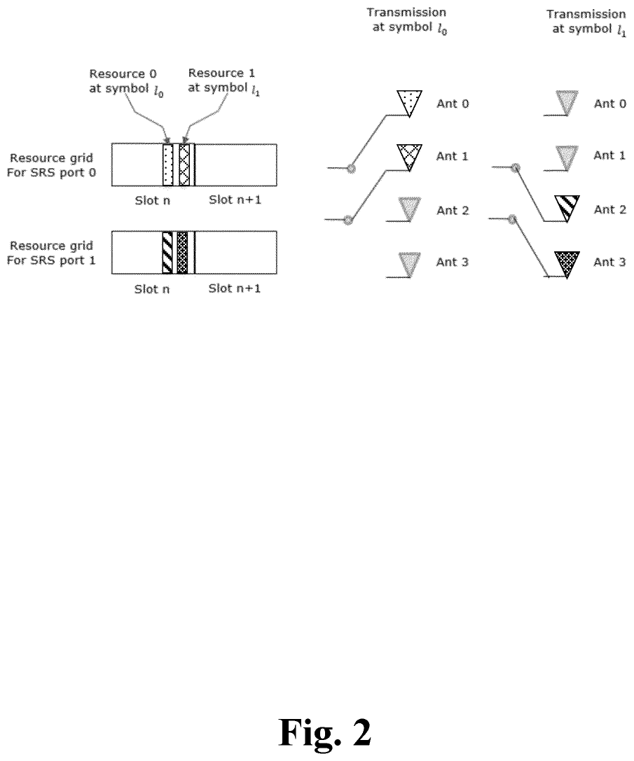

FIG. 2 is a diagram illustrating an example antenna switching scheme for Sounding Reference Signals (SRS) in an example UE according to the current disclosure. FIG. 2 shows a context in which the present disclosure can be applied. In a 3rd Generation Partnership Project (3GPP) Long Term Evolution (LTE) and/or 5G network, the radio network node has to configure the UE with sufficient resources, such as SRS resources, for the UE to perform antenna switching to obtain a full channel information and optimized antenna selections. In the example UE shown in FIG. 2, the UE has four antennas, herein referred to as Ant 0, Ant 1, Ant 2, and Ant 3, and two transmit (Tx) chains, in FIG. 2 referred to as port 0 and 1. In the example shown in FIG. 2, the UE uses Ant 0 for SRS transmissions at symbol l₀ with port 0 and Ant 1 for SRS transmissions at symbol l₀ with port 1. For transmissions at symbol l₁ the UE switches antennas and uses Ant 2 for SRS transmissions with port 0 and Ant 3 for SRS transmissions with port 1.

However, modern UEs may have a complicated radio frequency (RF) front end architecture, where multiple antennas are connected, but each antenna has unique properties, such as characteristics, in terms of bandwidth, Tx capability, etc. For example, a UE may have one main antenna covering all bands that this device supports and can both receive and transmit using the main antenna. In addition, the UE may have one or more antennas that can only support a subset of the supported bands, and some of them may only support receiving but not transmitting or transmitting but not receiving.

Therefore, for a device, such as a UE, in a given frequency band:
The device may have n antennas in total.
The device may have n receive (Rx) antennas and m transmit (Tx) antennas (in one or more example devices m<n)·
The device may have l Tx chains (where l<m).

A Tx chain herein means a cascade of electronic components and sub-units which may include amplifiers, filters, mixers, attenuators, and detectors, that are used for transmitting via an antenna. Each Tx chain may be connected to one or more antennas.

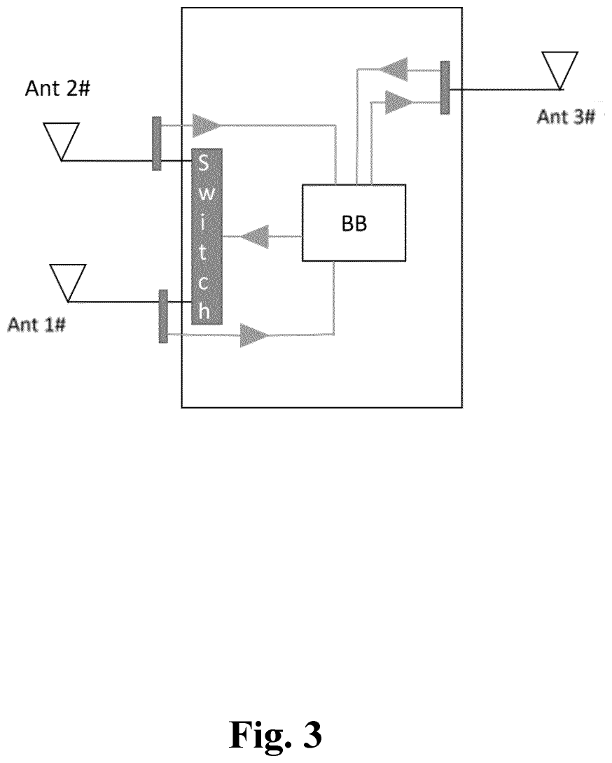

FIG. 3 shows an example UE equipped with, such as comprising, three antennas, herein referred to as Ant 1 #, Ant 2 #and Ant 3 #, and two Tx chains according to the current disclosure. FIG. 3 shows a context in which the present disclosure can be applied. the first antenna Ant 1 #and the second antenna Ant 2 #are connected to a common Tx chain via a switch, while the third antenna is connected to a separate Tx chain. For Single Input Single Output (SISO) operation, all three antennas can be used for Tx. However, for 2×2 MIMO, only certain combination of antennas can be used, for example, Ant #1+Ant #3 or Ant #2+Ant #3 but not Ant #1+Ant #2. Since Ant 1 #and Ant 2 #are switched they cannot be used for transmitting simultaneously. Ant 1 #and Ant 2 #may thus only be used using a Time Division Multiplexing (TDM) transmission scheme, where the transmission using Ant 1 #and Ant 2 #are offset in time. However, the antenna configuration may vary between UEs and the radio network node may not be aware of the actual antenna configuration of the UE.

With more antennas and more frequency bands implemented alone in the evolution of 5G devices, it becomes more and more complicated for the radio network node to understand how the UE can, such as is configured to, actually transmit, such as transmit SRS and/or data, and how many resources that need to be configured for the transmission. Therefore, additional information related to UE capability on transmission antennas may be needed by the radio network node to determine a correct resource configuration.

According to the current disclosures, the UE transmits information to the network node, that enables the network node to, based on the number of active channels, identify allowed and/or available antenna combinations at the UE. An antenna combination being available herein means that the antenna combination can be used, such as is allowed and/or is feasible to use, for example based on the UEs configuration, for contemporaneous transmission in a certain frequency band or at a certain transmission rank. Correspondingly, the antenna combination not being available herein means that the combination of antennas cannot be used, such as is not allowed and/or is not feasible to use, for contemporaneous transmissions in a certain frequency band or at a certain transmission rank. This may for example be due to the UEs antenna configuration not being configured to support the specific antenna combination. To enable the radio network node to understand the possible Tx configuration on the UE side, the UE may, according to one or more examples of the current disclosure, signal, such as transmit a message comprising information indicative of possible antenna combinations for Tx transmission for different transmission ranks. A transmission rank herein means the number of independent transmission layers. The UE may inform the radio network node, for each transmission rank, about which antenna combinations that can be used, such as are allowed and/or feasible to use. The information indicative of the possible antenna combinations may be transmitted as a table, a sequence and/or a list of possible antenna combinations. The transmission rank indicates the number of independent communication channels. For example, transmission rank 1 indicates that communication can be performed using 1 communication channel, such as using one antenna. A transmission rank 2 indicates that the UE can use two communication channels for simultaneous transmission, such as using two antennas. Using the antenna configuration in FIG. 3 as an example, the UE may report to the gNB that:
For a rank 1 transmission, it can perform SRS transmission over one antenna, such as over antenna 1, antenna 2 and/or antenna 3. The antennas may herein be referred to using the indices [1,2,3].
For rank 2 transmission on a single carrier, such as on a single frequency band, it can perform SRS transmission over a combination of antennas, such as over an antenna group, such as for example using the combination of antenna 1 and antenna 3 or antenna 2 and antenna 3, such as the antenna groups [(1 3), (2 3)].
For two-layer transmission on different carriers, such as on different frequency bands, similarly antenna groups can be indicated.

For rank>1 the list of antenna combinations for Tx transmission may, in one or more examples of the current disclosure, be reported as a per band, such as a per frequency band, capability. In other words, the UE may indicate in the message that for a certain band a certain combination of antennas can be used for transmitting.

In one or more example methods, the UE signals a message indicative of its antenna implementation to the radio network node. The message may for example comprise information indicative of one or more codebook entries illustrating and/or indicating allowed, such as supported, antenna configurations. Transmitting codebook entries may reduce the complexity of the signaling.

In one or more example methods, the UE transmits a preferred uplink transmission scheme to the radio network node, such as TDM or simultaneous transmission for a combination of antennas, such as over two or more antennas. The preferred uplink transmission scheme may be determined based on a downlink (DL) signal Reference Signal received Power (RSRP). Transmitting the preferred UL transmission scheme may assist the radio network node to configure the SRS resources accordingly.

For the radio network node to perform an accurate channel estimation, the radio network node needs to know which SRS resources are transmitted from which antennas of the UE. Therefore, the radio network node may configure the SRS resources to different combinations of antennas, such as different antenna groups, based on the capability it received from the UE. The radio network node may indicate to the UE to transmit the SRS sequences accordingly.

Upon the UE reporting the list of antenna combinations, such as antenna groups, as a per band capability, the antenna indices used in the reporting may be common for different bands. For example, if index 1 is reported in lists of two different frequency bands, the index refers to the same physical antenna. Thereby, the radio network node can determine whether there is a conflict between the frequency bands when using a certain antenna index, provided that the UE can only use one antenna for only one band at any given time. In other words, if the antenna with index 1 can be used by the UE for transmitting in two different frequency bands and the radio network node schedules the antenna with index 1 in a first frequency band the radio network node would know that the antenna with index 1 cannot be scheduled in a second frequency band.

In one or more example methods, a single UE antenna is configured to transmit on two bands, simultaneously. This property of the antenna may be signaled to the radio network node, such as indicated in the message transmitted to the radio network node. In one or more example methods, the UE may signal additional lists indicating multi-band capabilities. For example, signaling a list Bₘₙ={(1,2),(2,2),(2,1)} may indicate to the radio network node that the antenna combinations with indices (1,2), (2,2) and (2,1) can be used for simultaneous transmissions on bands m and n, respectively.

In one or more example methods, the UE may signal only non-allowed antenna combinations, such as antenna pairs, by indicating the indices of the antennas in the form of (1,1), (2,2), and so on. The non-allowed antenna combinations are antenna combinations that cannot be used for contemporaneous transmissions, such as transmissions existing at or occurring in the same period of time, at the UE. The UE may thus transmit an indication to the radio network node of unallowed antenna combinations. The unallowed antenna combinations may be indicated for a certain frequency band and/or for a transmission rank. Antenna combinations that are not signaled may indicate that these combinations are allowed, such as can be used by the UE for transmitting.

In one or more example methods, the UE may signal a general capability indicating that all antenna combinations are allowed, for any bands m, n.

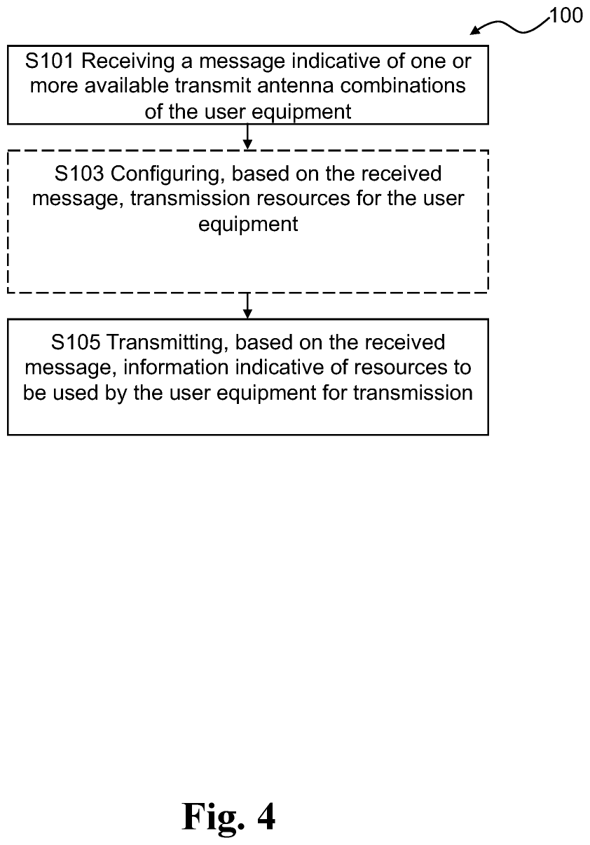

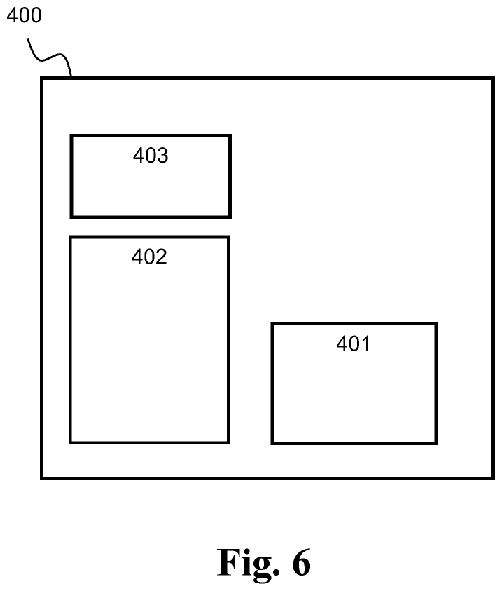

FIG. 4 shows a flow diagram of an example proposed method 100, performed by a radio network node according to the disclosure, for configuring transmission resources for a user equipment. The radio network node is the radio network node disclosed herein, such as the radio network node 400 of FIG. 1, and FIG. 6.

The method 100 comprises receiving S101, from the user equipment, a message indicative of one or more available transmit antenna combinations of the user equipment. Each transmit antenna combination is associated with one or more frequency bands. The transmit antenna combination being associated with one or more frequency bands herein means that the transmit antenna combination is allowable, such as can be used, in the frequency band. In some embodiments, associated with refers to transmit antenna combination being allowed, permissible, feasible etc. In other words, the network node receives information that enables the network node to identify transmit antenna combinations that can be used for the respective frequency bands, i.e., if the bands are contemporarily configured. The message may be anything carrying information, such as a data unit, such as a field, an indicator, a block, etc. The message may be transmitted over a control channel.

In one or more example methods, the message is indicative of one or more antenna groups associated with the one or more frequency bands. In one or more example methods, one or more of the individual antenna groups may comprise a plurality of antennas, such as antenna pairs.

In one or more example methods, the message is indicative of one or more transmission ranks associated with the one or more antenna combinations available. The message may for example indicate that certain antenna combinations are only available for a first transmission rank, such as transmission rank 1, and other antenna combinations are available for a second transmission rank, such as for transmission rank 2. In one or more example methods, the message may comprise information indicating that for rank 1 transmissions, the UE can perform transmissions, such as data and/or SRS transmissions, over one antenna, such as antenna [1,2,3]. For example, in some embodiments the message is indicative of which transmit antenna combinations that are allowed, permissible and/or feasible for the respective ranks.

In one or more example methods, the message may comprise information indicating that for a certain rank, such as for rank 2 transmission on a single carrier, such as on a single frequency band, the UE can perform transmissions, such as data and/or SRS transmissions, over a combination of antennas, such as using antenna groups [(1 3), (2 3)] in the example shown in FIG. 3.

In one or more example methods, the message may comprise information indicating that for two-layer transmission on different carriers, such as on different frequency bands, over a combination of antenna groups.

In one or more example methods, the transmit antenna combinations are indicated as codebook entries. The codebook entries may comprise the transmit antenna combinations, corresponding frequency bands, corresponding transmit schemes and corresponding transmission ranks for each transmit antenna combination. In one or more example methods, the UE may report one set of available transmit antenna combinations for each frequency band, the set of available transmit antenna configuration may be transmitted to the radio network node in the following example format {(1,1),(1,2),(1,3),(2,2),(2,3),(3,3)}, where each entry indicated within brackets is indicative of an available antenna combination for the specific frequency band combination. An entry comprising the same indices, such as the entries (1,1), (2,2), and (3,3), may indicate that these antenna can be used for transmission ranks >1, such as for rank-2 transmissions, on the frequency band.

In one or more example methods, the transmit antenna combinations are indicated as a table, a sequence, and/or a list of antenna groups and a corresponding frequency band capability for each antenna group. In other words, for each antenna group one or more frequency bands in which the antenna group can be used for contemporaneous transmissions may be indicated by the UE.

In one or more example methods, the message comprises a list of frequency bands and a corresponding combination of antennas available for each frequency band. In other words, the UE may indicate for each frequency band which antenna groups that can be used for contemporaneous transmissions in the frequency band.

In one or more example methods, the message comprises a list of frequency band groups and a corresponding combination of antennas available for each frequency band group. In one or more example methods, the UE may group the frequency bands and may for each group of frequency bands indicate the combination of antennas that can be used for contemporaneous transmission in the frequency band group. This may reduce the information that has to be signaled to the radio network node.

In one or more example methods, such as when the frequency band m is equal to frequency band n in the example list Bₘₙ discussed above, each entry in a combination of transmit antennas corresponds to a specific frequency band.

In one or more example methods according to the current disclosure, the UE may, for an example scenario having M frequency bands and an example UE having K antennas, send information indicative of M (M+1)/2 sets of transmit antenna combinations, where each set of transmit antenna combinations is associated with a respective set of frequency band combinations. In this example, the UE may be configured with two Tx chains and each set of antenna combinations may be a number of, ordered, pairs. Assume M=3, in other words that there are three available frequency bands. This means that there are six different frequency band combinations available, namely {(1,1),(1,2),(1,3),(2,2),(2,3),(3,3)}. The UE may indicate one set of transmit antenna combinations for each of the band combinations (1,1),(1,2),(1,3),(2,2),(2,3),(3,3). Assume that K=3, in other words that the UE has three transmit antennas.

The set of transmit antenna combinations corresponding to the frequency band combination (1,2) may be indicated in the form of the list and/or sequence B₁₂={(1,2),(2,1),(1,3),(3,3)}. Each entry of the sequence B₁₂, which is indicated within brackets, indicates an antenna combination that is allowable for the indicated frequency band combination. In this example the first position in the entry indicates the antenna that is allowable for the first frequency band in the frequency band combination and the second position in the entry indicates the antenna that is allowable for the second frequency band in the frequency band combination. For example, the entry (1,3) in B₁₂ means that if antenna 1 is operating in band 1, then antenna 3 can simultaneously operate in band 2. However, as entry (3,1) is not in the list, antenna 3 cannot operate in band 1 simultaneously as antenna 1 operates in band 2. Correspondingly, entry (3,3) in B₁₂ means that antenna 3 can be used for simultaneous transmission in band 1 and 2. However, as entry (2,2) is not in the list, then antennas 2 cannot simultaneously operate in band 1 and 2. This example is based on the example frequency band combination 1 and 2, however the same reporting format may apply to any frequency band combination (m,n).

In one or more example methods, the transmit antennas are indicated with a respective index. In one or more example methods, the indices may be numbers such as 1, 2, 3, etc. In one or more example methods, each transmit antenna has a common index for all frequency bands. When reporting the list of antenna groups, the UE may use common antenna indices for different frequency bands. For example, if index 1 is reported for two different frequency bands, the index refers to the same physical antenna in the UE. Thereby, the radio network node can determine whether there is a conflict between bands and can avoid any such combinations when using a certain antenna index, provided that the UE can only use one antenna for only one band at any given time.

In one or more example methods, the message comprises information indicative of one or more transmission schemes associated with each of the transmission antenna combinations. The message may for example indicate that a certain combination of antennas can only be used with a certain transmission scheme, such as using a switched transmission scheme, such as a TDM scheme. This may for example be the case for Ant 1 #and Ant 2 #in FIG. 3, since these antennas are connected to the same TX chain via the switch. In one or more example methods, each transmit antenna combination may be associated with the one or more frequency bands with a transmission scheme, such as using simultaneous transmission or switched, such as TDM, transmission. In other words, the message may indicate that a specific antenna combination can be used in the one or more frequency bands using the simultaneous transmission scheme and/or the switched transmission scheme.

In one or more example methods, the method 100 comprises configuring S103, such as scheduling, based on the received message, transmission resources for the user equipment. The radio network node may configure the transmission resources based on the indicated available transmit antenna combinations received from the UE. The radio network node may for example configure the transmission resources based on the indicated antenna combinations and the corresponding frequency bands, such that the UE is configured to use the antenna combinations in the corresponding frequency bands as indicated in the message received from the UE. The radio network node may only configure transmission resources that correspond to the indicated antenna combinations, frequency bands and/or transmission ranks. The radio network node may refrain, or at least attempt to refrain, from configuring resources for other antenna combinations, such as for non-allowed antenna combinations.

The method 100 comprises transmitting S105, to the user equipment, based on the received message, information indicative of resources to be used by the user equipment for transmission, such as for UL transmission and/or sidelink (SL) transmission between two UEs. The resources may be time and/or frequency resources. Transmitting S105 can be performed according to legacy scheduling operations. In one or more example methods, transmitting S105 may comprise only transmitting information indicative of resources that correspond to the indicated antenna combinations, frequency bands and/or transmission ranks. In one or more example methods, transmitting S105 may comprise refraining from, or at least attempting to refrain from, transmitting information indicative of resources for other antenna combinations, such as for non-allowed and/or non-available antenna combinations.

In one or more example methods, the resources are resources for contemporaneous transmission of one or more of Sounding Reference Signals, SRS, and data.

In one or more example methods, the information indicative of resources to be used by the user equipment comprises information indicative of which antenna combination the user equipment is to use for the indicated resources, such as for contemporaneous transmission in the indicated resources.

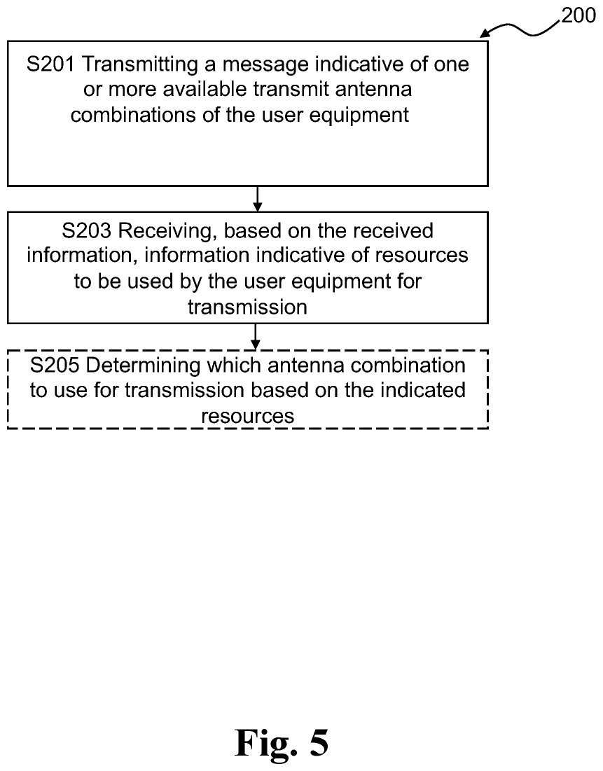

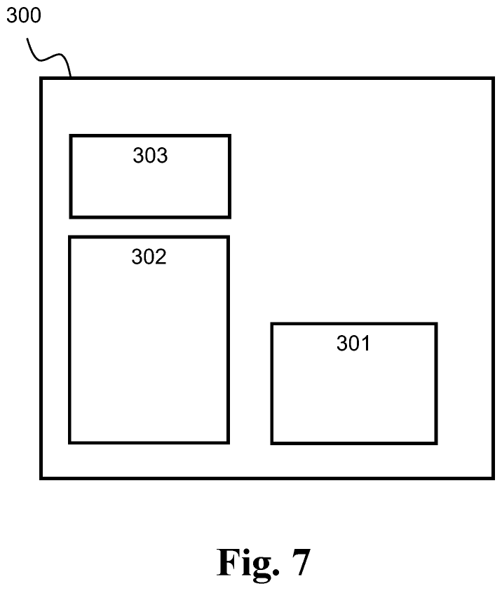

FIG. 5 shows a flow diagram of a corresponding example method 200, performed by a UE according to the disclosure, for enabling a radio network node to configure transmission resources for the user equipment is disclosed. The UE is the UE disclosed herein, such as the UE 300 of FIG. 1, and FIG. 7. In one or more example methods, the method 200 may be performed as part of a normal, such as a legacy, scheduling operation.

The method 200 comprises transmitting S201, to the radio network node, a message indicative of one or more available transmit antenna combinations of the user equipment. In one or more example methods, each transmit antenna combination is associated with one or more frequency bands. The message may be anything carrying information, such as a data unit, such as a field, an indicator, a block, etc. The message may be transmitted over a control channel.

In one or more example methods, the message is indicative of one or more antenna groups associated with the one or more frequency bands.

In one or more example methods, the message is indicative of one or more transmission ranks associated with the one or more antenna combinations available. The message may for example indicate that certain antenna combinations are only available for a first transmission rank, such as transmission rank 1, and other antenna combinations are available for a second transmission rank, such as for transmission rank 2. In one or more example methods, the message may comprise information indicating that for rank 1 transmissions, the UE can perform transmissions, such as data and/or SRS transmissions, over one antenna, such as antenna [1,2,3]. The antenna combination being available herein means that the antenna combination can be used, such as is allowed and/or is feasible to use, for example based on the UEs configuration, for contemporaneous transmission in a certain frequency band or at a certain transmission rank. Correspondingly, the antenna combination not being available herein means that the combination of antennas cannot be used, such as is not allowed and/or is not feasible to use, for contemporaneous transmissions in a certain frequency band or at a certain transmission rank. This may for example be due to the UEs antenna configuration not being configured to support the specific antenna combination.

In one or more example methods, the message may comprise information indicating that for rank 2 transmission on a single carrier, such as on a single frequency band, the UE can perform transmissions, such as data and/or SRS transmissions, over a combination of antennas, such as using antenna groups [(1 3), (2 3)] in the example shown in FIG. 3.

In one or more example methods, the message may comprise information indicating that for two-layer transmission on different carriers, such as on different frequency bands, over a combination of antenna groups.

In one or more example methods, the antenna groups may comprise a plurality of antennas, such as antenna pairs.

In one or more example methods, the transmit antenna combinations are indicated as codebook entries. The codebook entries may comprise the transmit antenna combinations, corresponding frequency bands, corresponding transmit schemes and corresponding contemporaneous transmission capability for each transmit antenna combination.

In one or more example methods, the transmit antenna combinations are indicated as a list of antenna groups and a corresponding frequency band capability of performing contemporaneous transmission for each antenna group. In other words, for each antenna group one or more frequency bands in which the antenna group can be used for contemporaneous transmissions may be indicated by the UE.

In one or more example methods, the message comprises a list of frequency bands and a corresponding combination of antennas available for each frequency band supporting contemporaneous transmission. In other words, the UE may indicate for each frequency band which antenna groups that can be used simultaneously for contemporaneous transmissions in the frequency bands.

In one or more example methods, the message comprises a list of frequency band groups and a corresponding combination of antennas available for each frequency band group. In one or more example methods, the UE may group the frequency bands and may for each group of frequency bands indicate the combination of antennas that can be used for contemporaneous transmission in the frequency band group. This may reduce the information that has to be signaled to the radio network node.

In one or more example methods, the transmit antennas are indicated with a respective index. In one or more example methods, the indices may be numbers such as 1, 2, 3, etc.

In one or more example methods, each transmit antenna has a common index for all frequency bands. When reporting the list of antenna groups, the UE may use common antenna indices for different frequency bands. For example, if index 1 is reported for two different frequency bands, the index refers to the same physical antenna in the UE. Thereby, the radio network node can determine whether there is a conflict between bands when using a certain antenna index, provided that the UE can only use one antenna for only one band at any given time.

In one or more example methods, the resources are resources for contemporaneous transmission of one or more of Sounding Reference Signals, SRS, and data.

In one or more example methods, the message comprises information indicative of one or more transmission schemes associated with each of the transmission antenna combinations. The message may for example indicate that a certain combination of antennas can only be used with a certain transmission scheme, such as using a switched transmission scheme, such as a TDM scheme. This may for example be the case for Ant 1 #and Ant 2 #in FIG. 3, since these antennas are connected to the same TX chain via the switch. In one or more example methods, each transmit antenna combination may be associated with the one or more frequency bands with a transmission scheme, such as using simultaneous transmission or switched, such as TDM, transmission. In other words, the message may indicate that a specific antenna combination can be used in the one or more frequency bands using the simultaneous transmission scheme and/or the switched transmission scheme.

The method 200 comprises receiving S203, from the radio network node, information indicative of resources to be used by the user equipment for transmission.

In one or more example methods, the information indicative of resources to be used by the user equipment comprises information indicative of which antenna combination the user equipment is to use for the indicated resources, such as for transmission in the indicated resources. In one or more example methods, the resources are resources for transmission of one or more of Sounding Reference Signals, SRS, and data.

In one or more example methods, the method 200 comprises determining S205, which antenna combination to use for transmission based on the information received from the radio network node, such as based on the indicated resources.

FIG. 6 shows a block diagram of an example radio network node 400 according to the disclosure. The radio network node 400 comprises memory circuitry 401, processor circuitry 402, and a wireless interface 403. The network node 400 may be configured to perform any of the methods disclosed in FIG. 5. In other words, the network node 400 may be configured for configuring transmission resources for a user equipment.

The radio network node 400 is configured to communicate with a user equipment, such as the user equipment node disclosed herein, using a wireless communication system.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The radio network node 400 is configured to receive (such as via the wireless interface 403), from the user equipment, a message indicative of one or more available transmit antenna combinations of the user equipment, wherein each transmit antenna combination is associated with one or more frequency bands. The radio network node 400 is configured to transmit (such as via the wireless interface 403), to the user equipment, based on the received message, information indicative of resources to be used by the user equipment for transmission.

Processor circuitry 402 is optionally configured to perform any of the operations disclosed in FIG. 4 (such as any one or more of S101, S103, and S105). The operations of the radio network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the radio network node 400 may be considered a method that the radio network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 6). Memory circuitry 401 is considered a non-transitory computer readable medium.

Memory circuitry 401 may be configured to store information, such as information indicative of available transmit antenna combinations, resources to be used by the UE for transmissions, frequency bands and/or transmission ranks associated with the combination of transmission antennas, in a part of the memory.

FIG. 7 shows a block diagram of an example UE 300 according to the disclosure. The UE 300 comprises memory circuitry 301, processor circuitry 302, and a wireless interface 303. The UE 300 may be configured to perform any of the methods disclosed in FIG. 6. In other words, the wireless device 300 may be configured for enabling a radio network node to configure transmission resources for the user equipment.

The UE 300 is configured to communicate with a network node, such as the radio network node disclosed herein, using a wireless communication system.

The UE 300 is configured to transmit (such as via the wireless interface 303), to the radio network node, a message indicative of one or more available transmit antenna combinations of the user equipment, wherein each transmit antenna combination is associated with one or more frequency bands.

The UE 300 is configured to receive (such as via the wireless interface 303), from the radio network node, based on the received information, information indicative of resources to be used by the user equipment for transmission.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The UE 300 is optionally configured to perform any of the operations disclosed in FIG. 5 (such as any one or more of S201, S203, S205). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the UE 300 may be considered a method that the UE 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store information, such as information indicative of available transmit antenna combinations, resources to be used by the UE for transmissions, frequency bands and/or transmission ranks associated with the combination of transmission antennas, in a part of the memory.

Examples of methods and products (network node and user equipment) according to the disclosure are set out in the following items:
Item 1. A method performed by a radio network node, for configuring transmission resources for a user equipment, the method comprising:
   receiving (S101), from the user equipment, a message indicative of one or more available transmit antenna combinations of the user equipment for contemporaneous transmission, wherein each transmit antenna combination is associated with one or more frequency bands, and
   transmitting (S105), to the user equipment, based on the received message, information indicative of resources to be used by the user equipment for transmission.
Item 2. The method according to Item 1, wherein the method comprises:
   configuring (S103), based on the received message, transmission resources for the user equipment.
Item 3. The method according to any one of the previous Items, wherein the message is indicative of one or more antenna groups associated with the one or more frequency bands.
Item 4. The method according to any one of the previous Items, wherein the message is indicative of one or more transmission ranks associated with the one or more antenna combinations available.
Item 5. The method according to any one of the previous Items, wherein the transmit antenna combinations are indicated as codebook entries.
Item 6. The method according to any one of the previous Items, wherein the transmit antenna combinations are indicated as a list of antenna groups and a corresponding frequency band capability for each antenna group.
Item 7. The method according to any one of the previous Items, wherein the message comprises a list of frequency bands and a corresponding combination of antennas available for each frequency band.
Item 8. The method according to any one of the previous Items, wherein the message comprises a list of frequency band groups and a corresponding combination of antennas available for each frequency band group.
Item 9. The method according to any one of the previous Items, wherein the transmit antennas are indicated with a respective index.
Item 10. The method according to Item 9, wherein each transmit antenna has a common index for all frequency bands.
Item 11. The method according to any one of the previous Items, wherein the resources are resources for contemporaneous transmission of one or more of Sounding Reference Signals, SRS, and data.
Item 12. The method according to any one of the previous Items, wherein the message comprises information indicative of one or more transmission schemes associated with each of the transmission antenna combinations.
Item 13. The method according to any one of the previous Items, wherein the information indicative of resources to be used by the user equipment comprises information indicative of which antenna combination the user equipment is to use for the indicated resources.
Item 14. A method performed by a user equipment, for enabling a radio network node to configure transmission resources for the user equipment, the method comprising:
   transmitting (S201), to the radio network node, a message indicative of one or more available transmit antenna combinations of the user equipment for contemporaneous transmission, wherein each transmit antenna combination is associated with one or more frequency bands, and
   receiving (S203), from the radio network node, information indicative of resources to be used by the user equipment for transmission.
Item 15. The method according to Item 14, wherein the information indicative of resources to be used by the user equipment comprises information indicative of which antenna combination the user equipment is to use for the indicated resources.
Item 16. The method according to Item 14 or 15, wherein the method comprises:
   determining (S205) which antenna combination to use for contemporaneous transmission based on the indicated resources.
Item 17. The method according to any one of the Items 14 to 16, wherein the message is indicative of one or more antenna groups associated with the one or more frequency bands.
Item 18. The method according to any one of the Items 14 to 17, wherein the message is indicative of one or more transmission ranks associated with the one or more antenna combinations available.
Item 19. The method according to any one of the Items 14 to 18, wherein the transmit antenna combinations are indicated as codebook entries.
Item 20. The method according to any one of the Items 14 to 19, wherein the transmit antenna combinations are indicated as a list of antenna groups and a corresponding frequency band capability for each antenna group.
Item 21. The method according to any one of the Items 14 to 20, wherein the message comprises a list of frequency bands and a corresponding combination of antennas available for each frequency band.
Item 22. The method according to any one of the Items 14 to 21, wherein the message comprises a list of frequency band groups and a corresponding combination of antennas available for each frequency band group.
Item 23. The method according to any one of the Items 14 to 22, wherein the transmit antennas are indicated with a respective index.
Item 24. The method according to Item 23, wherein each transmit antenna has a common index for all frequency bands.
Item 25. The method according to any one of the Items 14 to 24, wherein the resources are resources for contemporaneous transmission of one or more of Sounding Reference Signals, SRS, and data.
Item 26. The method according to any one of the Items 14 to 25, wherein the message comprises information indicative of one or more transmission schemes associated with each of the transmission antenna combinations.
Item 27. A radio network node comprising memory circuitry, processor circuitry, and a wireless interface, wherein the radio network node is configured to perform any of the methods according to any of Items 1-13.
Item 28. A user equipment comprising memory circuitry, processor circuitry, and a wireless interface, wherein the user equipment is configured to perform any of the methods according to any of Items 14-27.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-7 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

### APPENDIX

3GPP Rel-17supports UE Tx-switching with up to two simultaneous carriers. One of the objectives for Rel-18 is to support up to four carriers with the limitation that only up to two are used simultaneously [1].

WI objective 2

Study and if necessary, specify following enhancements for multi-carrier UL operation
[RAN1, RAN2, RAN4]

| • | UL Tx switching schemes across up to 3 or 4 bands with restriction of up to 2 Tx | |
|---|---|---|
| | simultaneous transmission for FR1 UEs, including mechanisms to enable more | |
| | configured UL bands than its simultaneous transmission capability and to support | |
| | dynamic Tx carrier switching across the configured bands for both single TAG and | |
| | multiple TAGs configurations (RAN1, RAN4) | |
| | ∘ | UE capability and RRC configuration related signalling (RAN2) |
| | ∘ | Note: strive for RAN1/2 design agnostic with the number of bands, i.e., common |
| | | design between 3 and 4 bands |
| | ∘ | Note: no additional TAG is introduced for UL transmission on a carrier without |
| | | corresponding DL carrier |
| | ∘ | Note: this objective does not target to extend the SUL framework to support |
| | | more than 1 SUL for 1 NUL |
| • | Switching time and other RF aspects, and RRM requirements for above UL Tx | |
| | switching schemes across up to 3 or 4 bands (RAN4) | |
| | ∘ | Note: Prioritize UL Tx switching across up to 3 bands is to be addressed first |
| | | and then that for up to 4 bands can also be addressed |

### Discussion

For any band combination, a UE indicates an associated capability (i.e., switchedUL or dualUL) to specify whether the UE supports simultaneous UL operation or not. The table below shows the available transmission strategies that can be configured depending on the UE capability for each two-band combination.

| | dualUL | switchedUL |
|---|---|---|
| Rank-2 | B1 + B1 | B1 + B1 |
| Rank-2 | B2 + B2 | B2 + B2 |
| Dual SISO | Simultaneous | TDM |
| SISO | B1 | B1 |
| SISO | B2 | B2 |

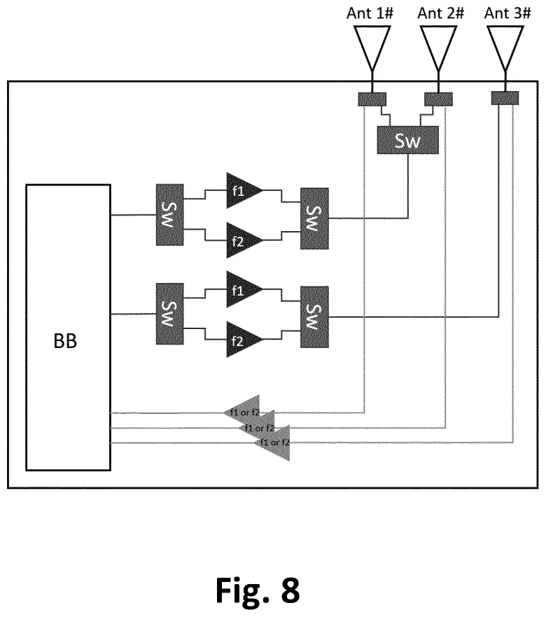

Adding more frequency bands, with the limitation that maximum two are configured simultaneously, we note that for the “Dual SISO” case and dualUL, it may not be possible for the UE to configure an arbitrary antenna. As an example, as shown in FIG. 8, a UE support simultaneous transmissions over antenna pairs [1,3] or [2,3] but would need TDM mode for UL transmission over antenna pair [1,2].

Observation 1: For the “Dual SISO” case and dualUL, it may not be possible for the UE to configure an arbitrary antenna.

In such case it may be beneficial to configure the UE according to a TDM scheme (associated with switchedUL). To achieve this, the gNB needs prior knowledge about what UE antenna combinations that support simultaneous operation in each band pair.

Proposal 1: Introduce a capability signal where UE declare what antenna combinations support simultaneous operation in a band pair.

As it is the gNB that configure the UE UL carriers, the decided UE Tx-configuration can be based on either the DL (UE reports) or UL performance (SRS). For TDD bands, reciprocity may be assumed, and DL performance can be used for the decision. However, in FDD bands, reciprocity may not be assumed, e.g., based on UE antenna implementation, and UL sounding may be need. Furthermore, the number of antennas supporting a frequency band in the UE are typically higher than the number of transmit ports, which, increase the number of SRS resources needed.

Different SRS configuration strategies can be used:
1. A single SRS resource in each frequency band, where the UE antenna selection is up to implementation, likely based on the strongest DL port.
2. An SRS resource for each UE Tx-port in each frequency band, where the UE antenna selection is up to implementation, likely based on the strongest DL ports.
3. An SRS resource for each UE Rx-port in each frequency band, where the UE is expected to use the same antennas as for the DL.
4. If the UE has more antennas than configured for the DL, all antennas available at each frequency band require an SRS resource. Then the UE would need to request, or signal, the number of available antennas.

Depending on both the UE antenna implementation and channel conditions different strategy for the UL channel sounding may be optimal. We propose that at least the upper 3 different SRS configurations shall be investigated for various channel conditions.

Observation 2: For FDD bands, UL channel sounding may need to take the number of available UE antennas into account.

Dynamic use of the 3 first different SRS transmit strategies above can be configured without additional signaling where the antenna switching is up to UE implementation. From a specification perspective, the UE may need to assume that the configured number of SRS implicitly configure one of the 3 first cases.

For the fourth case, where the number of antennas available for transmit are NOT the same as the UE Rx-capability (i.e., UE Rx MIMO support) the UE would need to indicate the number of available antennas for UL transmission in each frequency band.

Observation 3: For full UL antenna sounding, UE need to indicate the number of available antennas for UL.

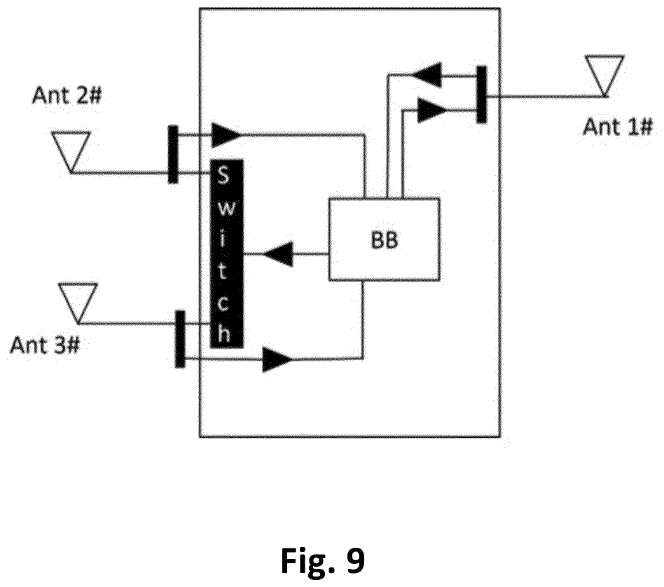

Finally, based on UE implementations, not all antenna combinations may support UL 2×2 MIMO transmissions and such limitation will be needed to share with the gNB in a capability signaling. As an example, as shown in FIG. 9, a UE with three antennas for UL may only support antenna combinations [1,2], [1,3] and not antenna combination [2,3] for UL MIMO operation.

Observation 4: Not any antenna combination may be supported for UL MIMO.

Proposal 2: UE need to indicate what antenna combinations that support UL MIMO transmissions.

### Conclusions

Here we list the Observations and Proposals made in this contribution
Observation 1: For the dual SISO case and dualUL, it may not be possible for the UE to configure an arbitrary antenna.
Observation 2: For FDD bands, UL channel sounding may need to take the number of available UE antennas into account.
Observation 3: For full UL antenna sounding, UE need to indicate the number of available antennas for UL.
Observation 4: Not any antenna combination may be supported for UL MIMO.
Proposal 1: Introduce a capability signal where UE declare what antenna combinations support simultaneous operation in a band pair.
Proposal 2: UE need to indicate what antenna combinations that support UL MIMO transmissions.

### REFERENCES

[1] RP-213577

### Conclusions

Here we list the Observations and Proposals made in this contribution
Observation 1: For the dual SISO case and dualUL, it may not be possible for the UE to configure an arbitrary antenna.
Observation 2: For FDD bands, UL channel sounding may need to take the number of available UE antennas into account.
Observation 3: For full UL antenna sounding, UE need to indicate the number of available antennas for UL.
Observation 4: Not any antenna combination may be supported for UL MIMO.
Proposal 1: Introduce a capability signal where UE declare what antenna combinations support simultaneous operation in a band pair.
Proposal 2: UE need to indicate what antenna combinations that support UL MIMO transmissions.

### REFERENCES

[1] RP-213577

1. A method performed by a radio network node, for configuring transmission resources for a user equipment, the method comprising:
receiving, from the user equipment, a message indicative of one or more available transmit antenna combinations of the user equipment for contemporaneous transmission, wherein each transmit antenna combination is associated with one or more frequency bands, and
transmitting, to the user equipment, based on the received message, information indicative of resources to be used by the user equipment for transmission.

2. The method according to claim 1, wherein the method comprises:
configuring, based on the received message, transmission resources for the user equipment.

3. The method according to claim 1, wherein the message is indicative of one or more antenna groups associated with the one or more frequency bands.

4. The method according to claim 1, wherein the message is indicative of one or more transmission ranks associated with the one or more antenna combinations available.

5. The method according to claim 1, wherein the transmit antenna combinations are indicated as codebook entries.

6. The method according to claim 1, wherein the transmit antenna combinations are indicated as a list of antenna groups and a corresponding frequency band capability for each antenna group.

7. The method according to claim 1, wherein the message comprises a list of frequency bands and a corresponding combination of antennas available for each frequency band.

8. The method according to claim 1, wherein the message comprises a list of frequency band groups and a corresponding combination of antennas available for each frequency band group.

9. The method according to claim 1, wherein the transmit antennas are indicated with a respective index.

10. The method according to claim 9, wherein each transmit antenna has a common index for all frequency bands.

11. The method according to claim 1, wherein the resources are resources for contemporaneous transmission of one or more of Sounding Reference Signals, SRS, and data.

12. The method according to claim 1, wherein the message comprises information indicative of one or more transmission schemes associated with each of the transmission antenna combinations.

13. The method according to claim 1, wherein the information indicative of resources to be used by the user equipment comprises information indicative of which antenna combination the user equipment is to use for the indicated resources.

14. A method performed by a user equipment, for enabling a radio network node to configure transmission resources for the user equipment, the method comprising:
transmitting, to the radio network node, a message indicative of one or more available transmit antenna combinations capable of contemporaneous transmission by the user equipment, wherein each transmit antenna combination is associated with one or more frequency bands, and
receiving, from the radio network node, information indicative of resources to be used by the user equipment for transmission.

15. The method according to claim 14, wherein the information indicative of resources to be used by the user equipment comprises information indicative of which antenna combination the user equipment is to use for the indicated resources.

16. The method according to claim 14, wherein the method comprises:
determining which antenna combination to use for contemporaneous transmission based on the indicated resources.

17. The method according to claim 14, wherein the message is indicative of one or more antenna groups associated with the one or more frequency bands.

18. The method according to claim 14, wherein the message is indicative of one or more transmission ranks associated with the one or more antenna combinations available.

19. The method according to claim 14, wherein the transmit antenna combinations are indicated as codebook entries.

20. The method according to claim 14, wherein the transmit antenna combinations are indicated as a list of antenna groups and a corresponding frequency band capability for each antenna group.

21-28. (canceled)
